(19) United States
(12) Patent Application Publication
(10) Pub. No.: US 2014/0317533 A1
(43) Pub. Date: Oct. 23, 2014

(54) INFORMATION TECHNOLOGY TOOL FOR EXCHANGE OF QUESTIONS AND RESPONSES

(71) Applicant: ASPASIA – HOLDING TRICOLORE DI PARTECIPAZIONE E SVILUPPO S.P.A., Reggio Eilia (IT)

(72) Inventor: Werther BADODI, Reggio Emilia (IT)

(73) Assignee: ASPASIA – HOLDING TRICOLORE DI PARTECIPAZIONE E SVILUPPO S.P.A., Reggio Eilia (IT)

(21) Appl. No.: 14/258,224

(22) Filed: Apr. 22, 2014

(30) Foreign Application Priority Data
Apr. 22, 2013 (IT) RE2013A000029

(51) Int. Cl. H04L 29/06

(52) U.S. Cl. CPC H04L 65/403
USPC 715/753

(57) ABSTRACT

An information technology tool based on the world wide web is provided that includes one or more servers, at least one of which possesses an electronic processor and a storage unit containing an information code which, when carried out by the electronic processor, commands the server to perform a process logic that includes the steps of receiving from a first user an input containing a question, selecting at least a second user from a group of users enabled such as to respond to the question contained in the input, communicating the question to the second user, receiving from the second user an input containing a response to the question, and communicating the response to the first user.

The present invention relates in general to an information technology tool based on the world wide web, by means of which an exchange of data between two or more users is enabled using the information tool system via a procedure based on questions and responses.

As is known, very numerous on-line applications at present exist, which enable users to search for data on the web as responses to their queries.

A typical example of these applications is represented by search engines, which via a search for key words enable users to view internet pages which in some way deal with arguments inherent to the search carried out, enabling the users to access information and therefore potential responses to the queries they have made.

Although search engines implement progressively more evolved logics, which are semantic and structured and increase the probability of tracing web pages highly relevant to the argument being searched, it is quite clear that this type of application does not enable tracing a direct response to a particular question, but rather a series of data which can help the user to form an answer autonomously.

Further, these applications do not in general enable having responses too complex questions or in any case to “human” questions, such as for example opinions or advice on any argument or theme.

To respond to these requests, also known are on-line applications which enable users to receive information directly from other users of the same application, by management of an exchange of questions and answers via the web.

The applications are generally based on a logic which also enables a user to formulate a question, which is published on a web page functioning as a virtual noticeboard. With the virtual noticeboard, the question is visible by all the other users of the application, each of whom can, at his or her discretion, provide an answer which will be published on the same web page so as to be visible to all users, and thus also by the person who has posed the question.

A drawback of the applications consists however in the fact that there is no particular interest on the part of the users to respect to the posted questions, if not for a personal desire to contribute to the discussion or the social network, and it often occurs that some questions do not receive responses or receive them over long delays with respect to the moment in which the question is posed either approximately or incompletely.

A further drawback consists in the fact that any user of these applications can respond to the questions asked by other users, independently of the user's qualification, experience and competence, with the result that sometimes the responses provided can be wrong.

Though these drawbacks are generally mitigated by the possibility of receiving responses from numerous users, as well as the possibility of publishing comments and judgements with respect to the responses received, the common perception is that this type of application is not particularly reliable and in any case not usable in a case where a relatively rapid response is required.

Consequently it has been found that the applications of this type have a user community which is relatively limited and in general decline, which tends to further amplify the above-mentioned drawbacks, as it tends to reduce the number of users who might have the necessary knowledge to respond to the questions posed by others.

Naturally the reduction of the user community also has an economic impact, as it translates into a smaller number of accesses, with a consequent reduction in revenue from publicity or other sources of income associated to the broadcasting of the on-line application.

An aim of the present invention is therefore to provide an information tool based on the web which enables an exchange of questions and answers among users, which can be perceived as more reliable with respect to the tools at present known.

A further aim is to provide an information tool which has the ability to attract and keep the users who participate in it, thus increasing the user pool, broadcasting and therefore possibly also the earnings in economic terms associated to the tool itself.

A further aim of the present invention is to attain the mentioned aim with a solution that is relatively simple, rational and economical.

These aims are attained by the characteristics of the invention as reported in the independent claims. The dependent claims delineate preferred and/or especially advantageous aspects of the invention.

In particular, in an embodiment of the present invention an information tool is provided based on the web, which comprises one or more servers, at least one of which exhibits an electronic processor and a storage unit containing an information code which, when performed by the electronic processor, commands the server to perform a process logic which comprises steps of:

receiving from a first user an input containing a question, selecting at least a second user from a group of users enabled to respond to the question contained in the input, communicating the question to the second user,
receiving from the second user an input containing a response to the question, and
communicating the response to the first user.

With this solution an information tool is obtained in which the exchange of questions and answers does not happen directly and freely among users, but it is always managed and mediated by the process logic, which can for example transmit the application only to users qualified to supply a pertinent response, thus improving the credentials of the tool.

Since, further, the responses are supplied by persons, this tool enables its users to post “human” questions, among which for example complex or requests for opinions, advice or ideas, and to receive likewise “human” responses.

A characteristic aspect of the invention consists in the fact that the step of communicating the question to the second user and the step of communicating the response to the first user are carried out in a sort of “reserved modality”.

By “reserved modality” is meant that the questions are transmitted only to the enabled users who have been selected by the process logic, and the responses are transmitted only to the user who generated the question, while all the other users of the information tool are in no way informed of this question-and-answer exchange.

In other words, the questions and answers are not published on a public web-site, for example on a virtual notice-board, to which each registered user can accede, but are reserved among those who participate in the question-and-answer exchange, creating a one-to-one communication between the person formulating the question and the responder.

In this reserved way, the users will have fewer inhibitions in asking questions, even in a case in which the questions might be banal or to an extent “personal”, as the questions will be read only by those who have been selected by the process logic as suitable to respond, who in turn will be less inhibited in supplying the answers, knowing that their responses will be received and read only by the person asking the question.

Thanks to this particular, use of the information tool can be widespread, increasing the user pool, the popularity of the tool and thus indirectly also the functionality thereof. To further facilitate use of this information tool, in a further preferred aspect of the invention the step of communicating the question to the second user and the step of communicating the answer to the first user are carried out in “anonymous mode”.

By “anonymous” mode it is meant that the user receiving the question is not aware of the identity of the person who formulated the question, who is in turn not aware of the identity of the person or persons who provide the answer. Identity naturally refers not only to the real identity of the interested persons but also a virtual identity such as a nickname or any other identifying term.

In this way, each user who asks a question or provides an answer will have, as sole referent, the information tool, and will therefore feel freer to participate without risking being recognized and directly exposed to the other users. The user's perception is that it is always the information tool which asks the question and it is always the information tool which provides the response.

In an aspect of the invention, the step of selecting the second user (who responds to the question) includes: attributing a points amount to each user of the enabled user group, and

selecting the second user performing on the enabled user group a probabilistic sampling strategy configured such that the probability of selection of each user of the group is proportional to the points attributed thereto.

With this solution all enabled users for responding to a certain question (or a category of questions) can be selected, thus preventing that the responses are supplied always by the same people, and therefore increasing participation.

At the same time, it is however guaranteed that the frequency with which a user is called to respond to certain questions (or categories of questions) is linked to her or his points total (or rating). In this way the users are encouraged to increase their points total, which will be subordinated to their participation in this service, their competences and the quality of their responses, thus obtaining a certain degree of trust on the part of the users and guaranteeing good reliability and quality in the responses supplied by the information tool.

In regard to this, a preferred embodiment of the invention includes the process logic comprising further steps of:

after having communicated the answer to the first user (the user who has posed the question), receiving from the first user an input containing an evaluation of the answer,
using the evaluation such as to change points attributed to the second user (the one who has provided a response).

In this way, the second user will be encouraged to supply responses as complete and reliable as possible, with the aim of obtaining a positive evaluation and increase her or his points total.

In a further preferred aspect of the invention, the process logic comprises further steps:

counting the time that has passed between the communication of the application to the second user and the receiving of the answer,
providing an evaluation of the counted time,
using the evaluation to change points attributed to the second user.

In this way, the second user is encouraged to supply responses as rapidly as possible, with the aim of obtaining a positive evaluation and increasing her or his points total.

On the other hand, the information tool also aims to make users posing the questions more responsible.

In this regard, in an aspect of the invention the process logic comprises further steps of:

attributing a credit to the first user,
after having received the input containing the question, reducing the credit attributed to the first user.

With this solution, a user is guaranteed not to be able to use the information tool in an indiscriminate way, but must in some way participate.

In an aspect of the present invention, the process logic can include a further step of inhibiting the first user from asking questions, if the credit attributed thereto is lower than a predetermined threshold value.

In a further preferred aspect of the invention, the process logic comprises further steps of:

after having communicated the response to the first user (the user who has posed the question), detecting an event indicating the fact that the first user has provided an input containing an evaluation of the response;
increasing the credit attributed to the first user.

In this users posing questions are encouraged also to supply an evaluation of the responses to their questions, with the aim of reacquiring the credit previously spent and therefore establishing a collaborative behaviour which enables users providing the responses to increase their points totals and therefore supporting the information tool.

In an embodiment of the invention, the process logic can in particular comprise steps of:

selecting from the group of enabled users a plurality of second users,
communicating the question to each of the second users,
receiving from each of the second users an input containing an answer to the question, and
communicating to the first user at least one of the answers received from the second users.

With this solution, for each question, the information tool can collect a multiplicity of responses, from various enabled users, which can be provided to the user posing the question altogether or one at a time on the basis of various criteria.

One of these criteria can be for example initially communicating to the first user only the response received first in chronological order.

This approach has the advantage of more effectively stimulating the users who have received the question to send a response as soon as possible, so as to have a greater possibility of receiving an evaluation by the questioner and therefore increasing her or his points total.

In an aspect of this embodiment, the process logic comprises further steps of:

receiving from a user an input containing a request to take part in the group of enabled users, and
sending the user a questionnaire at least a further response from among those received by the second users.

In practice, the providing of further responses can be subordinated to an explicit request on the part of the first user, who may not be satisfied by the first response or simply might desire to have one or more further opinions on a determined theme.

In this case too, the process logic can include providing the responses in the chronological order with which they were sent to the selected users.

In relation to the theme of the users enabled to respond to a question (or category of questions), in an aspect of the invention the control logic sets up the enabled user group by means of steps of:

receiving from a user an input containing a request to take part in the group of enabled users,
sending the user a questionnaire containing a plurality of questions,
receiving from the user the responses to the questions,
supplying an evaluation of each response,
calculating an amount of points according to the evaluations supplied,
adding the user to the enabled user group if the amount of points calculated is greater than a predetermined threshold value.

In this way, the users enabled to respond to a certain question (or category of questions) can be only users having demonstrated that they possess appropriate competence in the theme under discussion, thus increasing and improving the qualitative level of the responses that the information tool will supply to all the other users in normal use.

The points attributed to each user following the questionnaire can further be used as a starting points total for the user, and be increased on the basis of the evaluation that the other users will provide to the subsequent responses produced by him.

In a further aspect of the invention, the process logic can include further steps of:

receiving from a user an input containing a request for publication on a social network one of more items of data relating to the activity of the user connected to the information technology tool,
publishing the data in the personal page of the user on the social network.

In this way, a user can then some of his or her data published on her or his personal page of an external social network, such as for example the enrolment to the information tool and/or the questions posed by him and the responses received (preserving the anonymity of those who have responded), and/or the responses he has provided (preserving the anonymity of those who have posed the questions), and/or his or her own points acquired by responding to the questions.

In this way, via the information instrument, a user can for example create a reputation in a determined category of questions or arguments, quantified by his or her own points total, and choose to publish it on a social network (for example Linked-In or Facebook), thus gaining in personal image credit.

This last opportunity also encourages the user to actively participate in the information tool, increasing the efficiency, diffusion and popularity.

Further characteristics and advantages of the invention will emerge from a reading of the following description provided by way of non-limiting example, with the aid of the figures illustrated in the accompanying tables of drawings.

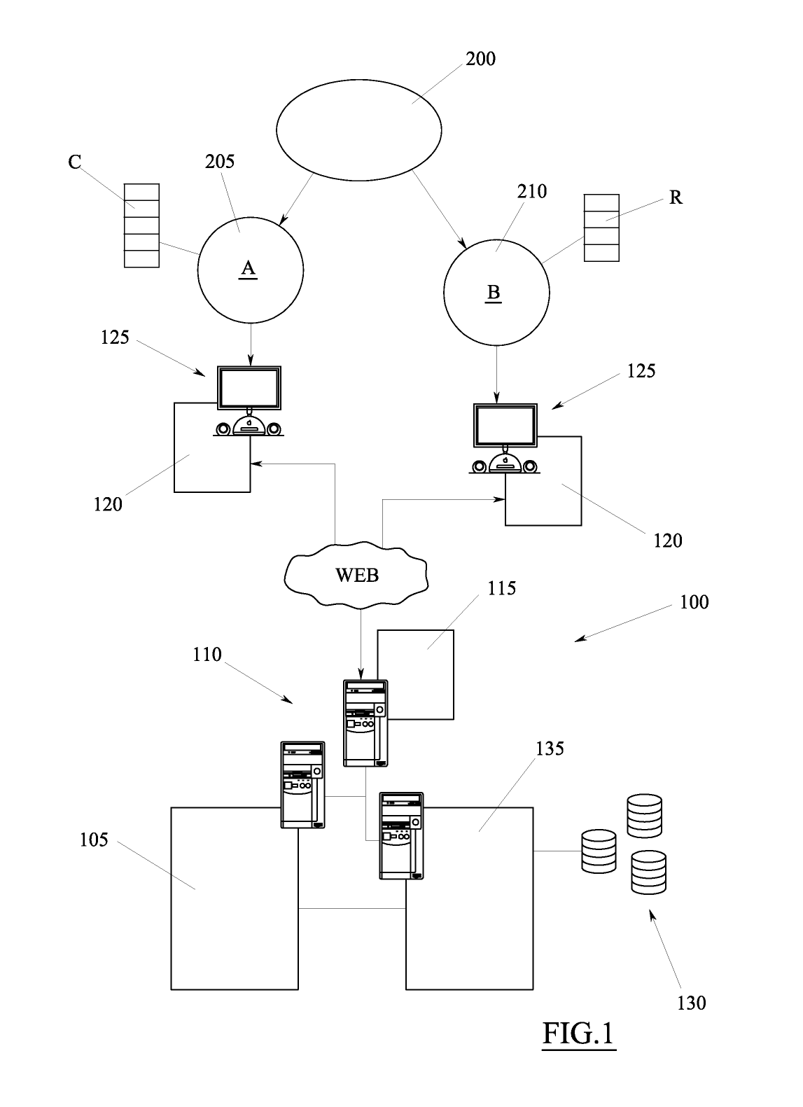

FIG. 1 is a block diagram which illustrates some components of the functional module system used for realising an information tool according to an embodiment of the present invention.

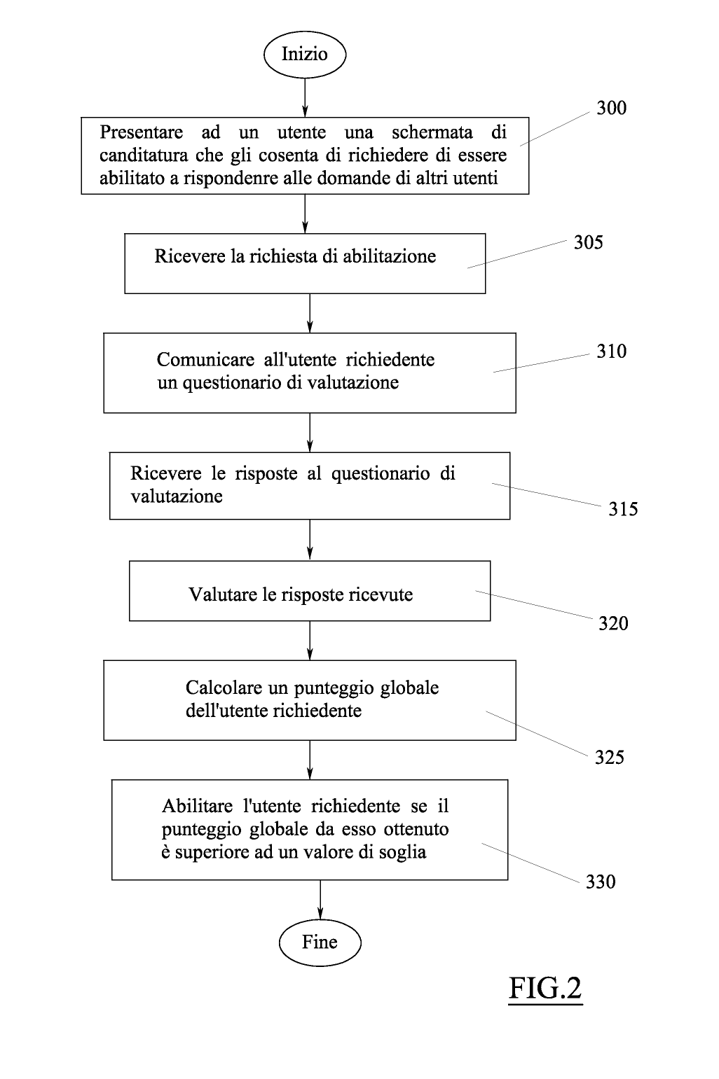

FIG. 2 is a flow chart representing a procedure which can be followed by the process logic to enable a user to respond to the questions posed by other users.

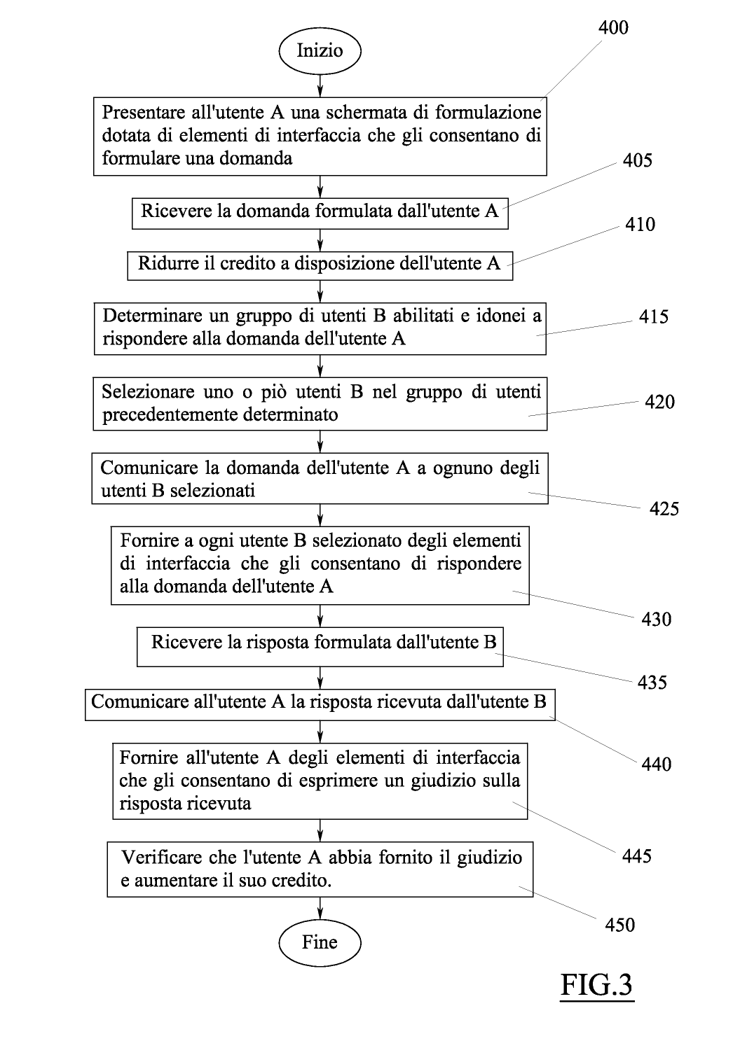

FIG. 3 is a flow chart representing a procedure which can be followed by the process logic in order to enable a question-answer exchange among the users of the information tool.

In the embodiment of FIG. 1, the invention discloses an information technology tool 100 based on the world wide web (e.g. the internet) which primarily comprises a process logic 105 which is memorized, in the form of a data access code, in one or more servers 110 connected to one another. The servers 110 comprise at least an electronic processor (not illustrated), which can carry out the access code and therefore actuate the process logic 105. At least one of the servers 110 can further include a web application 115 configured such as to exchange data (for example documents and web pages) with internet navigation programs 120 (browsers) which are conventional and are operated by a plurality of remote terminals 125.

The remote terminals 125 can be computers which carry out the navigating program 120 in order to access the information tool 100 and the functionalities made available by the process logic 105. The remote terminals 125 can also comprise portable processing devices, among which for example mobile telephones, laptops and computer tablets, which are provided with hardware and a navigation program for accessing the web.

Additionally or alternatively, the web application 115 might contain protocols enabling exchange of data, not with navigating programs 120 (browsers) but with dedicated programs which are stored and carried out by the terminals 125, such as those which normally called “apps” and which are installed on portable devices, such as mobile telephones and computer tablets.

These dedicated programs can be programmed to be carried out by the specific operating system of the device on which they are installed. For example, these programs can use interfaces or programming platforms which are unique for the particular device and operating system on which they are stored and from which they are operated.

The information tool 100 can further comprise one or more databases 130 which can contain the data connected to the process logic 105 of the information tool 100. These databases 130 can be stored in one or more storage units, which in turn can be localized on a single server or distributed on a plurality of servers 110. The databases 130 can interface with the process logic 105 via a management application 135, which can be stored and operated by one or more of electronic processors associated to the server 110.

On the basis of this system structure, the process logic 105 includes definition of a user group 200, i.e. a user pool which can access and use the information tool 100. This user group 200 can be populated by a normal registration or enrolments procedure which requires that each potential new user supplies some personal data, among which for example: name and surname, email address, date of birth, sex, city of residence, languages spoken, etc. After providing this data, the user can receive or create access credentials to the information tool 100, typically a user name, a password and possibly also a nick-name, which are memorized and stored in the databases 130.

The process logic 105 further includes the user group 200 being sub-divided into two user sub-groups, of which an A user sub-group 205 who can only ask questions, and a B user sub-group 210 that can only provide responses.

All the users belonging to the user group can automatically be classified as A users on registering. Each A user can further be initially assigned a certain number of credits C, i.e. a number or any other quantitative index representing a total of credit.

B users can be enabled to respond to any question or can be further sub-divided by question category to which they are allowed to provide responses, such that the questions relating to a certain category (e.g. an argument or theme) can receive responses only from B users enabled for that specific category. The question categories included by the process logic 105 can be very wide-ranging and can be changed and/or updated. Purely by way of example, the categories included by the process logic 105 can be selected from among the following group: accessories, food, love, sentiments, architecture, art, astronomy, cinema, confidential, cosmetics, cuisine, culture, law, penal law, discotheques, economics, wine bars, finance, body culture, geography, information technology, legal, literature, fashion, clothing, music, nature and science, pizzerias, pubs, restaurants, health and well-being, shoes, sport, history, technology, leisure time, life.

B users can be further sub-divided by qualification with respect to the category of pertinent questions, i.e. according to the type of approach to the category of questions. Purely by way of example, the qualifications included in the process logic 105 can be the following: intellectual, expert, artist, professional, enthusiast. In this case too, the qualifications accepted by the process logic 105 can be changed and/or updated.

In order to be classified in the B user group, a registered user must pass an enabling test.

FIG. 2 illustrates a flow chart which illustrates for example an enabling procedure, which can begin when the user has completed the access procedure to the information tool 100, by inserting her or his credentials (for example user name and password).

The enabling procedure commences a step 300, when the process logic 105 shows the user, via a terminal 125, a page (for example a web page) relating to candidature. This candidature page can contain interfacing elements, such as drop menus, text links or others, which enable the user to select the category or categories of questions for which she or he desires to be enabled to respond. Each user can select an unlimited number of categories, or can be constrained by the process logic 105 to select only a limited number thereof (for example a maximum of 3). For each selected category, the process logic 105 can show the user a further page, or simply other interfacing tools, which enable the user to select her or his qualification (intellectual, expert, artist, professional, enthusiast) which he requests for that particular category. The candidature page can lastly comprise an interfacing tool, for example a virtual key, by means of which the user confirms and sends her or his request to the process logic 105.

During the enabling procedure step 305, the process logic 105 receives the enabling request presented by the user via the candidature page and the information contained therein. This data can be acquired in real time, gradually as the user selects from the candidature page, or can be acquired all together when the user confirms the request.

On the basis of this information, during the enabling procedure step 310, the process logic 105 communicates an evaluation questionnaire to the user. This questionnaire can contain a series of questions (appropriately predisposed and memorized in the database 130), with various levels of difficulty, which can relate to the requested categories or be of a general character, for example logic or behavioural. The questionnaire can be communicated to the user via the terminal 125, one or more web pages, for example, containing the questions and the interfacing tools which enable the user to supply the responses.

At the enabling procedure step 315, the process logic 105 receives the responses to these questions. The responses can be acquired in real time, progressively as the user responds to each single question or can be acquired all together for example when the user confirms she or he has completed the questionnaire.

For each question, during the enabling procedure step 320, the process logic 105 performs an evaluation of the response. This evaluation can be expressed by a numerical vote or any other quantitative index which represents an evaluating judgement of the response. For example, the process logic 105 can assign a predetermined vote for each exact answer, and no vote in the case of a wrong answer. In addition or alternatively, the evaluation expressed by the process logic 105 can also depend on the rapidity with which the user responds to each question.

During the enabling procedure step 325, the process logic 105 uses the evaluations made for calculating an overall points total R obtained by the user. For example, the user points total can be represented simply by the sum of the votes obtained.

Lastly, at the enabling procedure step 330, the process logic 105 can compare the overall points total R with a predetermined threshold value and add the user to the B user group memorized in the database 130 only if the overall points total is higher than the threshold value. In the opposite case, the user is rejected and is not classified as a B user.

On the basis of the overall points total R, the process logic 105 can further automatically attribute to the user a certain level of competence, i.e. a knowledge level with respect to the category or categories for which she or he has asked for acceptance and has passed the test. Purely by way of example, the levels of competence involved by the process logic 105 can be the following: beginner, skilled, professional, evangelist. The levels of competence in the process logic 105 can be subject to changes and/or updating. The process logic 105 can lastly inform the user of the result achieved with the enabling procedure, by showing her or him, via the terminal 125, a web page with an appropriate message.

With a set-up of A users and B users, the information tool 100 enables each A user to post a question and receive a response.

FIG. 3 illustrates a flow chart showing an example of the question-response procedure according to the present invention. This question-and answer procedure can begin after an A user has completed an access step to the information tool 100, for example by entering her or his credentials (for example user and password).

The question-answer procedure starts at step 400, when the process logic 105 shows the user A via the terminal 125, a web page in which a question can be formulated. In this context, by question any question is intended, also comprising requests for opinions, advice and ideas. The formulating page can include interfacing elements, such as drop menus, textual links or others, which enable the A users to select the category of questions to which she or he is directed, for example a text entry box, which enables the A user to place her or his question. The formulating page can also enable the A user to select, via corresponding interfacing elements, also other variables of interest, such as for example the qualification of the person who will respond to the question (for example intellectual, expert, artist, professional, enthusiast), the geographical location and/or the language of the response. The formulation page can lastly comprise an interfacing tool, for example a virtual key, via which the A user confirms and sends her or his question to the process logic 105.

During the question-and-answer step 405, the process logic 105 receives the formulated question from the A user and the other information associated with it, if any.

After having received this data, during the question-and-answer procedure step 410, the process logic 105 can reduce the amount of the credit C of the A user. In other words, in order to post a question and receive and answer, the A user will have to spend a certain part of the credit C at her or his disposal. If the A user has no remaining credit, or insufficient credit, the process logic 105 might inhibit her or him from asking questions or in any case might not proceed after the question but notify the user A of the situation. The credit C spent by the A user to post a question can be a fixed and predetermined amount, or might depend on the category of question or other options. In some embodiments, the process logic 105 might enable the A user, via appropriate interfacing elements of the formulation page, also to request that her or his question be answered by B users having a precise level of competence (e.g. beginner, skilled, professional, evangelist). In this case, the credit C spent to post the question might be assessed according to the level of competence requested.

After having established the availability of the credit and updated the amount by subtracting the amount spent, in the question-and-answer procedure step 415 the process logic 105 can determine a group of B users suitable for responding to the question received. This determination can be done primarily on the basis of the category of question selected by the A user, i.e. considering only the B users enabled for that specific category. If the A user has indicated a qualification and/or a level of competence and/or a language and/or a geographical location, the process logic 105 can limit the enabled group of users to only B users who also respond to these specifications. In a case where the A user has not selected any of these further specifications, the process logic 105 can ignore them or evaluate them autonomously, for example by limiting the group of enabled users to only B users who speak the same language as the A user or who are in the same geographical region. Further, the process logic 105 can limit the user group enabled only to the B users who are also connected to the information tool 100 (on-line), ignoring those who are off-line or even those who declare themselves to be unavailable.

Once the B user group has been defined as suitable for responding, during step 420 of the question-and-answer procedure, the process logic 105 selects one or more B users from the group. This selection can be entirely casual. This selection can more preferably be made using the Monte Carlo statistical method, for example by carrying out a probabilistic sampling strategy configured in such a way that the probability of each B user in the group of being selected is proportional to a rating attributed thereto. The initial points attributed to each B user can be for example the overall points R calculated at the end of the enabling questionnaire. In this way, the selection is done in a substantially random way, giving many B users the possibility of participating, but on a statistical scale the probability of each B user of being selected is in any case proportional to her or his rating R; all of which encourages the B users to increase their points in the ways that will become apparent in the following.

After having selected one or more B users, at step 425 of the question-and-answer procedure the process logic 105 communicates the question to the selected B user or users. In order to make this communication, the process logic 105 can send to the selected B user or users a notification of the fact that they have been asked to respond to a question. This notification can be made by means of any messaging system, including email, SMS text messages, other text messages, instant messages, data feed systems enabling receiving updated information on web pages or directly on resident applications, and other ways too. Independently of the sending of the notification, when one of the selected B users accesses the information tool 100 by entering his or her credentials from a terminal 125 (for example user name or password), the process logic 105 can show the B user a customized screen (for example a web page) containing the question that has been asked of him or her.

In conformity with the process logic 105, only the selected B users can have access to the question, which remains reserved and is not published in any page or public noticeboard accessible by the other registered users, who therefore cannot be aware thereof. It is further specified that the question-and-answer procedure includes the process logic 105 preserving the anonymity of the A user who has asked the question, i.e. not providing anyone, not even the B users selected to respond, any information which might identify the A user who has posted the question (not even the nick-name, if any).

After a B user has perused the question, the procedure step 430 of the question-and-answer procedure includes the process logic 105 providing the B user with interfacing elements, for example a text-entering box, which enable the B user to formulate the response. These interfacing elements can be present in the same page containing the question, or can be entered in a separate response page. In any case, the response screen page might also contain other interfacing elements which can enable the B user to attach other documents to the response (for example JPEG, BNP, PNG, etc.) and/or external links and/or mail addresses which can support and complete the response. The interfacing page can also comprise the interfacing elements which enable the B user to signal the process logic 105 that the question posed by the A user is not appropriate, for example it does not belong to the declared category or includes inadmissible contents. In this way, a control is allowed of the behaviour of the A user with respect to the information tool 100 and, after a certain number of signallings, the A user might be suspended or even removed from the service. The response page can lastly comprise an interfacing tool, for example a virtual key, by means of which the B user confirms and sends her or his response to the process logic 105.

In step 435 of the question-and-answer procedure, the process logic 105 receives the response formulated by the B user and the documents, if any, attached and/or external links and/or email addresses.

Alternatively or additionally to what is described, some embodiments of the information tool 100 might include the notification being sent to the selected B users contains also the question formulated by the A user. In this case, the process logic 105 might enable each B user to formulate and sent her or his response by means of the same messaging system used for the notification, for example via email or text messaging, simply by responding to the notification received.

Independently of this, after having received the response or responses from the B user or users selected, at step 440 of the question-and-answer procedure, the process logic 105 communicates to the A user at least one of the responses received. For example, the process logic 105 can communicate to the A user the first response received in chronological order. To make this communication, the process logic 105 can sent the A user a notification of the fact that his or her question has received a response. The notification can be made using any messaging system, comprising the ones listed herein above. Independently of the sending of the notification, when the A user accesses the information tool 100 by entering, from his or her terminal 125, his or her credentials (for example user name and password), the process logic 105 can show the A user a customized screen (i.e. a web page) containing the response that has been sent him, comprising any enclosed documents and/or the links and/or the indicated email addresses.

The response page can also contain other interfacing elements, for example a virtual button, which the A user can activate if he or she wishes to receive another response to his or her question, for example because he or she is not satisfied by the first response or simply because he or she wishes to have a further opinion, advice or idea. When these interfacing elements are activated, the process logic 105 can include communicating to the A user a further response from those received by the B users, for example the second response received in chronological order. This request for a further response can be repeated many times by the A user and could be subordinated to a further credit cost C.

It is however stressed that with the process logic 105 only the A user having placed the question can have access to the response/s, which therefore remain reserved and are not published on any public page or noticeboard accessible by other registered users, which further specify that question-and-answer procedure includes the process logic 105 preserving the anonymity of the B users which provide the response, i.e. nobody, not even the A user who posted the question, can access any datum that might identify the B users who have provided a response (not even the nickname can be accessed).

Each time the A user sees a response, the question-and-answer procedure step 445 includes the process logic 105 providing the A user of the interfacing elements which enable her or him to express an opinion on the response received. The interfacing elements can be for example a list of text links which express a numerical or qualitative evaluation of the response, and among which the A user can select the most appropriate response. For example, a list of qualitative judgements can comprise the following judgements: rejected, satisfactory, thank you, good idea, excellent. In this way, the process logic 105 acquires the judgement supplied by the A user and uses it to vary the rating R of the B user who has provided the response. For example, should the A user express a numerically-based judgement, the number can be directly added to the points total R of the user B. In a case in which the user expresses a qualitative judgement, the process logic 105 can attribute a corresponding numerical value to the points total R of the B user who provided the response.

The process logic 105 can further include increasing the points total R of the B user on the basis of the response time. For example, the process logic 105 can count the time that has passed between the instant in which the B user is informed of the question and the instant in which the response was received, and attribute a numerical evaluation to this time (for example inversely proportional thereto), such as to give value to rapidity. This numerical evaluation can then be used to modify the points total R of the B user, for example simply by adding it to the points total R or using it as a coefficient to be applied to the judgement expressed by the A user in relation to the merits of the response.

During step 450 of the question-and-answer procedure, the process logic 105 verifies that the A user has effectively supplied a judgement for each response received. If the process logic 105 detects that the A user has supplied the judgement, it refunds the A user with the credit C spent to have the response. If the process logic 105 detects that the A user has not provided any judgement to the response, the credit spent is not refunded. In this way, the A users are stimulated always to supply a judgement on the responses received, increasing the points of the B user supplying them, and thus creating a virtuous circle which sustains the information tool 100.

In an aspect of the information tool 100, the process logic 105 can be interfaced with one or more external social networks, such as for example Facebook, Twitter, Linked-In, Foursquare and others besides. In particular, the process logic 105 can supply each A and B user with the chance to request some data relating to activities connected to the information tool 100 be published on one or more of the social networks. Following this request, the process logic 105 can automatically publish this data in the personal page of the user on the requested social network. By way of example, the shareable data can comprise: the enrolment or registration on the information tool 100, contents relating to the user's properties (for example questions posted and responses received) as well as the rating R and therefore the level of competence obtained by the user in the various categories of questions. In this way, the information tool 100 gives the possibility to its users, in particular the B users, to make public their abilities to provide ideas and responses on determined themes, and in the same way gives the possibility to the A users to share the contents of the responses that they have received. The set of shareable data can obviously be decided and defined by each user via appropriate interfacing elements of the terminal 125.

Obviously an expert in the sector can make modifications of a technical-applicational nature to the foregoing, without forsaking the scope of the invention as claimed below.

1. An information technology tool (100) based on the world wide web and comprising one or more servers (110), at least one of which possesses an electronic processor and a storage unit containing an information code which, when carried out by the electronic processor, commands the server to perform a process logic which comprises steps of:
receiving from a first user (A) an input containing a question,
selecting at least a second user (B) from a group of users enabled to respond to the question contained in the input, communicating the question to the second user (B), receiving from the second user (B) an input containing a response to the question, and communicating the response to the first user (A).

2. The tool (100) of claim 1, wherein the step of communicating the question to the second user (B) and the step of communicating the response to the first user (A) are carried out in a reserved mode.

3. The tool (100) of claim 1, wherein the step of communicating the question to the second user (B) and the step of communicating the answer to the first user (A) are carried out in an anonymous mode.

4. The tool (100) of claim 1, wherein the step of selecting the second user (B) comprises: attributing a points amount (R) to each user of the enabled user group,
selecting the second user (B) by performing on the enabled user group a probabilistic sampling strategy configured such that the probability of being selected of each user in the group is proportional to the points (R) attributed thereto.

5. The tool (100) of claim 1, wherein the process logic (105) comprises further steps of: after having communicated the answer to the first user (A), receiving from the first user (A) an input containing an evaluation of the answer,
using the evaluation such as to change points (A) attributed to the second user (B).

6. The tool (100) of claim 1, wherein the process logic (105) comprises further steps of: counting the time that has passed between the communication of the question to the second user (B) and the receiving of the answer, providing an evaluation of the time counted, using the evaluation to change a points total (R) attributed to the second user.

7. The tool (100) of claim 1, wherein the process logic (105) comprises further steps of:
attributing a credit (C) to the first user (A),
after having received the input containing the question, reducing the credit (C) attributed to the first user (A).

8. The tool (100) of claim 7, wherein the process logic (105) comprises a further step of inhibiting the first user (A) from asking questions if the credit (C) attributed thereto is lower than a predetermined threshold value.

9. The tool (100) of claim 7, wherein the process logic (105) comprises further steps of:
after having communicated the response to the first user (A), detecting an event indicating the fact that the first user (A) has provided an input containing an evaluation of the response;
increasing the credit (C) attributed to the first user (A).

10. The tool (100) of claim 1, wherein the process logic (105) comprises steps of:
selecting from the group of enabled users a plurality of second users (B),
communicating the question to each of the second users (B), receiving from each of the second users (B) an input containing an answer to the question, and communicating to the first user (A) at least one of the answers received from the second users (B).

11. The tool (100) of claim 10, wherein the at least a response is the response received first in a chronological order.

12. A tool (100) according to claim 10, wherein the process logic (105) comprises further steps of:
receiving from the first user (A) an input containing a request for a further response, and
communicating at least a further response to the first user from among those received from the second users (B).

13. The tool (100) of claim 1, wherein the process logic (105) sets up the user group via steps of:
receiving from a user an input containing a request to take part in the group of enabled users,
sending the user a questionnaire containing a plurality of questions,
receiving from the user the responses to the questions,
supplying an evaluation of each response,
calculating an amount of points (R) according to the evaluations supplied,
adding the user to the enabled user group if the amount of points (R) calculated is greater than a predetermined threshold value.

14. The tool (100) of claim 1, wherein the process logic (105) includes further steps of: receiving from a user an input containing a request for publication on a social network one of more items of data relating to the activity of the user connected to the information technology tool (100), publishing the data in the personal page of the user on the social network.
